(19) United States
(12) Patent Application Publication
(10) Pub. No.: US 2022/0352769 A1
(43) Pub. Date: Nov. 3, 2022

(54) STATOR FOR BRUSHLESS MOTOR OR GENERATOR

(71) Applicant: INTEVA PRODUCTS, LLC, Troy, MI (US)

(72) Inventor: Vincent CONDAMINET, Donnay (FR)

(21) Appl. No.: 17/713,750

(22) Filed: Apr. 5, 2022

(30) Foreign Application Priority Data
Apr. 6, 2021 (FR) 21/03517

(51) Int. Cl. H02K 1/16; H02K 3/02; H02K 1/02; H02K 5/02

(52) U.S. Cl. CPC H02K 1/165; H02K 3/02; H02K 1/02; H02K 5/02; H02K 2213/03

(57) ABSTRACT

A stator assembly for use with a brushless geared motor assembly, including: a stack of several steel laminations, each of the steel laminations include several teeth extending inwardly from a yoke portion of each of the steel laminations, wherein an inner shape and an outer shape of each yoke portion have the same polygon shape for both the inner shape and outer shape of the yoke portion.

### CROSS REFERENCE TO RELATED APPLICATIONS

This application claims priority under 35 U.S.C. § 119 to the following French Patent Application No. FR 21/03517, filed on Apr. 6, 2021, the entire contents of which are incorporated herein by reference thereto.

### BACKGROUND

Exemplary embodiments pertain to the art of brushless motor assemblies and stator assemblies for brushless gear motors.

The regular shape of a stator of a brushless motor is circular or squared. For small motors, with only a few space in slots to fill the copper coils, it is complicated to optimally fill the slots. This means the motor will operate under its optimal power capacity.

Accordingly, it is desirable to provide a stator where an optimal amount of copper can be used.

### BRIEF DESCRIPTION

Disclosed is a stator assembly for use with a brushless geared motor assembly, including: a stack of several steel laminations, each of the steel laminations include several teeth extending inwardly from a yoke portion of each of the steel laminations, wherein an inner shape and an outer shape of each yoke portion have the same polygon shape for both the inner shape and outer shape of the yoke portion.

In addition to one or more of the features described above, or as an alternative to any of the foregoing embodiments, the teeth and their corresponding yoke portion are all formed from a single unitary piece comprising a steel lamination.

In addition to one or more of the features described above, or as an alternative to any of the foregoing embodiments, the teeth and their corresponding yoke portion are separately formed and secured to each other to form the steel lamination.

In addition to one or more of the features described above, or as an alternative to any of the foregoing embodiments, the number of edges of the polygon shape is equal to the number of teeth of the stator.

In addition to one or more of the features described above, or as an alternative to any of the foregoing embodiments, the teeth have and the yoke portion have a constant thickness.

In addition to one or more of the features described above, or as an alternative to any of the foregoing embodiments, each of the steel laminations has a hexagon shape.

In addition to one or more of the features described above, or as an alternative to any of the foregoing embodiments, further including a first end cap part and a second end cap part, wherein the first end cap part covers partly a first end of the stator assembly and the second end part covers partly a second opposite end of the stator assembly.

In addition to one or more of the features described above, or as an alternative to any of the foregoing embodiments, the first end cap part is secured to the second end cap part by a plurality of fasteners.

In addition to one or more of the features described above, or as an alternative to any of the foregoing embodiments, the first end cap part and the second end cap part each have two or more open areas where the stack of several steel laminations are viewable.

In addition to one or more of the features described above, or as an alternative to any of the foregoing embodiments, the first end cap part and the second end cap part are formed from plastic.

A brushless gear motor assembly including the stator assembly of anyone of the preceding paragraphs (0004-0013).

In addition to one or more of the features described above, or as an alternative to any of the foregoing embodiments, the brushless gear motor assembly includes a rotor assembly, a gearbox and an electronic control board.

In addition to one or more of the features described above, or as an alternative to any of the foregoing embodiments, further including a first end cap part and a second end cap part, wherein the first end cap part covers partly a first end of the stator assembly and the second end part covers partly a second opposite end of the stator assembly.

In addition to one or more of the features described above, or as an alternative to any of the foregoing embodiments, the first end cap part is secured to the second end cap part by a plurality of fasteners.

In addition to one or more of the features described above, or as an alternative to any of the foregoing embodiments, the first end cap part and the second end cap part each have two or more open areas where the stack of several steel laminations are viewable and the first end cap part and the second end cap part are formed from plastic.

### BRIEF DESCRIPTION OF THE DRAWINGS

The following descriptions should not be considered limiting in any way. With reference to the accompanying drawings, like elements are numbered alike:

FIG. 1 is an exploded view of a brushless motor in accordance with the present disclosure;

FIG. 2 is a perspective view of a brushless motor in accordance with the present disclosure;

FIG. 3 is another perspective view of a brushless motor in accordance with the present disclosure;

FIG. 4 is a perspective view of a stator assembly in accordance with the present disclosure; and

FIG. 5 is a cross-sectional view of the stator assembly in accordance with the present disclosure.

### DETAILED DESCRIPTION

A detailed description of one or more embodiments of the disclosed apparatus and method are presented herein by way of exemplification and not limitation with reference to the Figures.

The present disclosure relates to a brushless gear motor assembly for certain vehicle applications such as window regulator and sunroof applications. Although other applications are contemplated. Using brushless technology allows the elimination of the brush commutation noise that appears with conventional DC motors.

A stator of a brushless motor sometimes has a different inside configuration as compared to its outside configuration. As such, this may create saturation issues at the minimum thickness of the yoke of the stator. The present disclosure proposes to modify the external shape of the stator in order to fill a maximum of copper in the slots, while preserving a continuous yoke thickness and by this way avoid magnetic saturation issues.

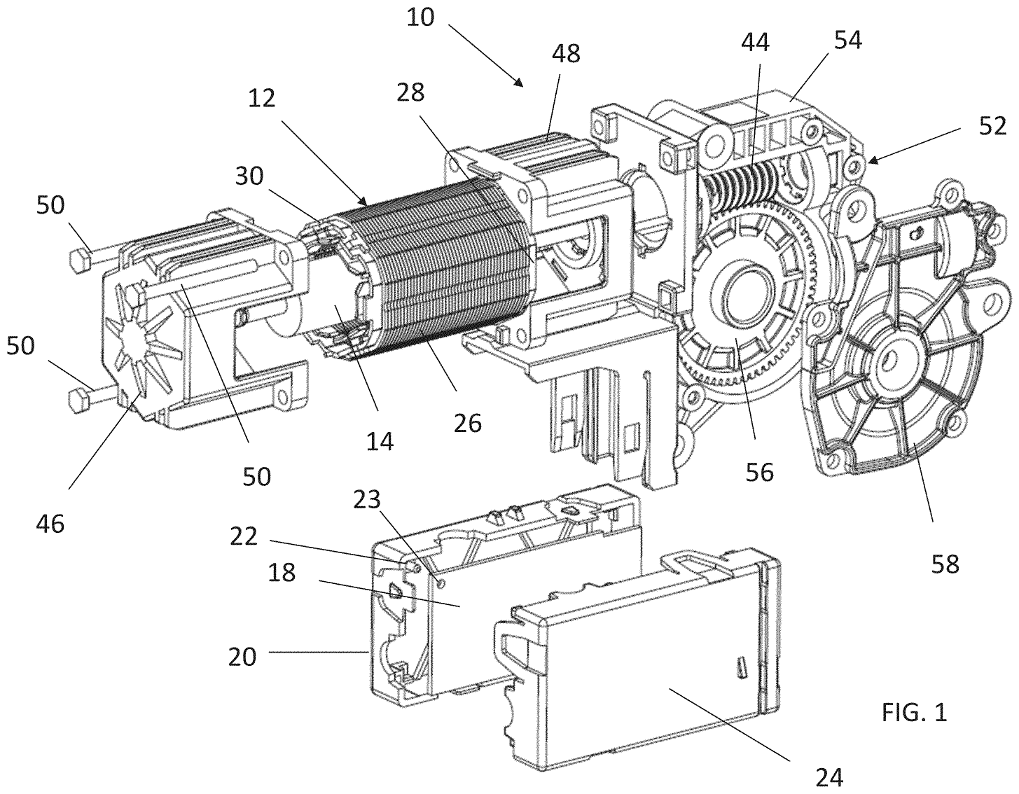

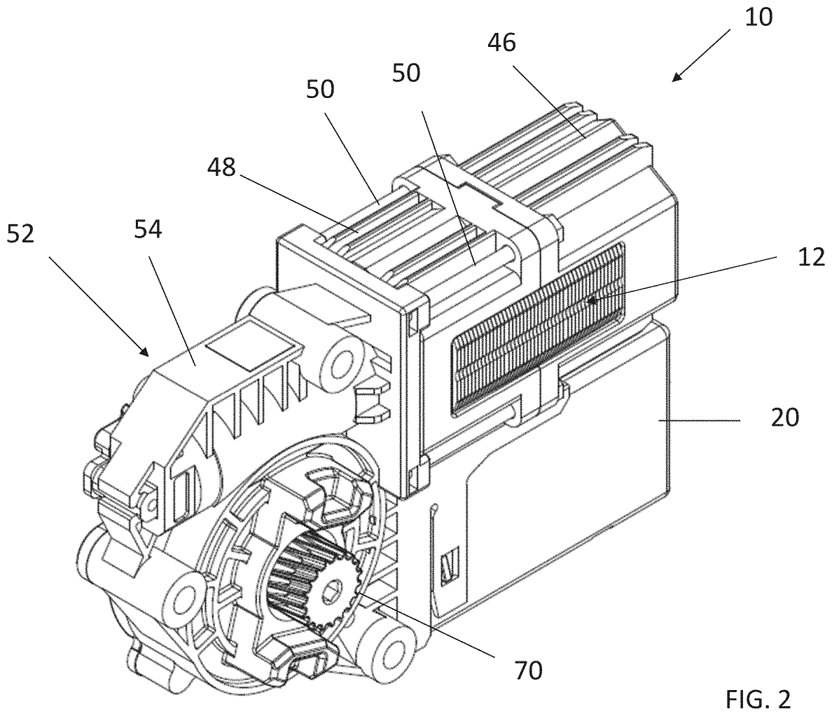

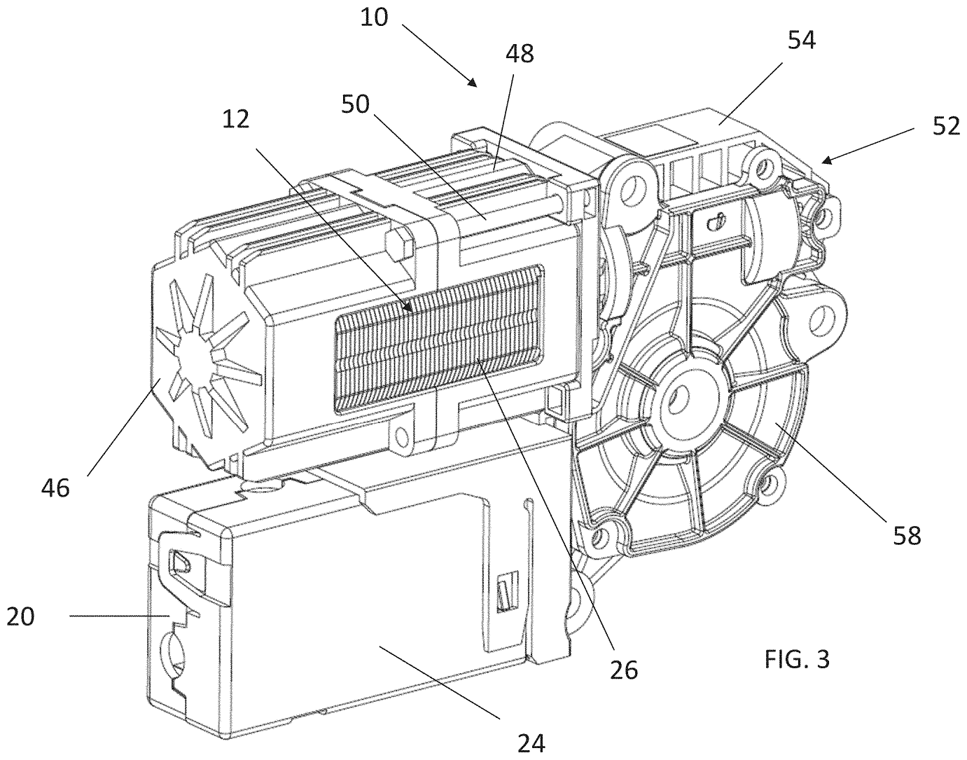

Referring now to at least FIGS. 1-5, the present disclosure relates to a brushless gear motor assembly 10. The brushless gear motor assembly 10 includes a stator assembly or sub assembly 12 and a rotor assembly or subassembly 14, a gearbox 16 and an electronic control board or electronic control unit 18.

The electronic control board or electronic control unit 18 is housed into a housing 20, which in one embodiment may be a plastic part. The electronic control board or electronic control unit 18 may be guided into the housing with a cylinder 22 that passes through an opening 23 in the electronic control board or electronic control unit 18 and locked with the help of clips. There are three main sectors on the board; the first is dedicated to an external power supply connection; the second is the electronic components region; and the third is for the connection of the 3 phases of the motor and optionally other connections related to the rotor position sensing device.

The electronic control board or electronic control unit 18 is covered by housing cover 24, which may be a plastic part.

The stator subassembly 12 is composed of a steel lamination stack 26 and two plastic caps 28, 30. The stator subassembly 12 has a number of arms, which are a multiple of 3. The plastic caps 28 and 30 prevent wound copper wires of the arms of the stator to be cut by sharp corners. They also house conductive plugs to connect the 3 phases to the electronic control board or electronic control unit 18.

The rotor subassembly 14 is composed of a steel shaft, on which is mounted a steel core cylinder and magnets. The magnets can be segments or a ring mounted on a surface of the core cylinder. The magnets may also be buried in the rotor core. A worm screw 44 is mounted on the shaft of the rotor subassembly 14.

An first end cap part 46 covers partly a first end of the stator assembly 12 and a second end part covers partly a second opposite end of the stator assembly 12. The first end cap part 46 is secured to the second end cap part 48 by a plurality of fasteners 50. The first end cap part 46 and the second end cap part 48 when secured to each other are long enough to hold the stator assembly 12. The first end cap part 46 and the second end cap part 48 each have two or more open areas where the stator stack 26 is apparent or viewable, so that the overall thickness of the motor 10 is reduced. In other words, by reducing the width of the first end cap part 46 and the second end cap part 48 on at least two sides so the stator stack 26 is apparent, the overall thickness of the motor 10 is reduced. The first end cap part 46 is equipped with a stop and a bearing in order to rotationally receive the shaft of the rotor subassembly 14. The second end cap part 48 is also equipped with a bearing in order to rotationally receive the shaft of the rotor subassembly 14.

The second end cap part 48 is secured to a gearbox subassembly 52. The gearbox subassembly 52 includes a main casing or housing 54, a pinion wheel or gear 56, and a cover 58. The gearbox subassembly 52 also includes a stopper and a bearing for an end of the shaft of the shaft of the rotor subassembly 14.

Pinion wheel or gear 56 also includes a pinon gear 70 that protrudes from the gearbox subassembly 52. The electronic control board or electronic control unit 18 via housing 20 and cover 24 is secured to the gearbox subassembly 52.

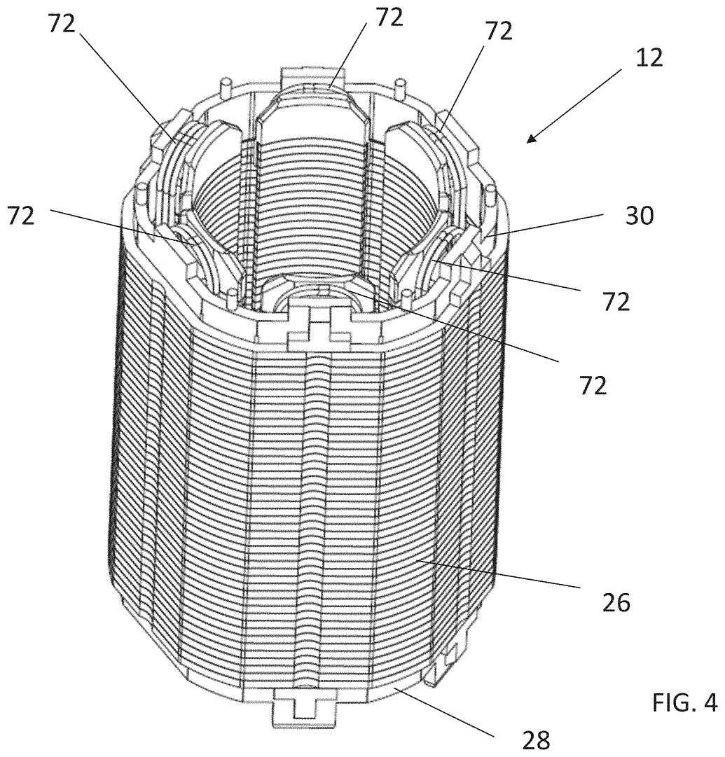

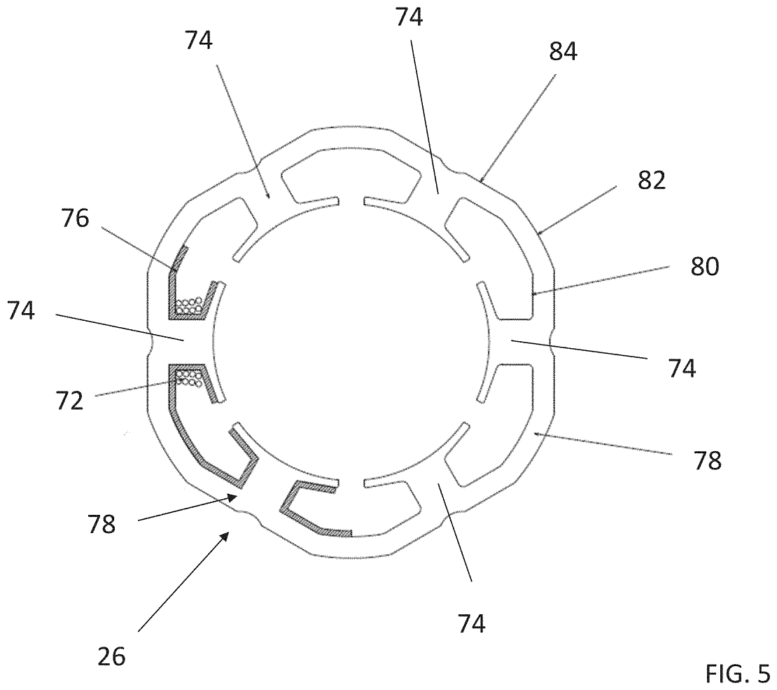

Referring now to at least FIGS. 4 and 5, the stator assembly 12 for use with the brushless geared motor assembly 10 is illustrated. As mentioned above two plastic parts or insulating parts 28 and 30 are used on each end of the core of the stator assembly to support windings or copper coils 72 of the stator assembly 12. Note in FIG. 5 only one winding 72 of the motor is illustrated.

As illustrated, the stator assembly 12 comprises a stack of several steel laminations 26, which form the stator core of the brushless motor or generator 10. The laminations 26 are composed of several teeth 74, on which copper coils 72 are wound. Also shown is an insulator 76 that is located between the coils 72 and the steel lamination 26.

A yoke portion 78 comprising at least one tooth 74 of each steel lamination 26 is provided. In one embodiment, the yokes 78 and their corresponding teeth 74 are all formed from the same part (e.g., a single unitary piece) or a plurality of yokes 78 comprising one tooth 74 are segmented and separately connected together. As illustrated, the inner shape 80 and the outer shape 82 of each yoke 78 have the same polygon shape 84 for both the inner 80 and outer 82 sides of the yoke 78.

In accordance with the present disclosure, the number of edges of the polygon shape 84 is equal to the number of teeth 74 of the stator 12. This allows, for constant tooth 74 and yoke thicknesses, which extend the slot filling capacity of the copper coils 72. In addition and by keeping the yoke thickness constant the stator assembly 12 can avoid magnetic saturation at some points. Another feature of the present disclosure is to round the outer edges 82 for both avoiding sharp corners for the stamping process, and keeping a compact stator 12. FIG. 5 shows a lamination 26 having a hexagon shape.

FIG. 5 illustrates a single segment 26 having a hexagon shape, which includes 6 teeth 74. The present disclosure will help to increase the power over mass ratio of the brushless motor 10 by optimizing the coils 72 wound about the teeth 74 of the segments 26.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates to one or more structural limitations of a device that are required for the device to perform the function or operation for which the device is configured.

The disclosure illustratively disclosed herein may be practiced in the absence of any element which is not specifically disclosed herein.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A stator assembly for use with a brushless geared motor assembly, comprising:
a stack of several steel laminations, each of the steel laminations include several teeth extending inwardly from a yoke portion of each of the steel laminations, wherein an inner shape and an outer shape of each yoke portion have the same polygon shape for both the inner shape and outer shape of the yoke portion.

2. The stator assembly as in claim 1, wherein the teeth and their corresponding yoke portion are all formed from a single unitary piece comprising a steel lamination.

3. The stator assembly as in claim 1, wherein the teeth and their corresponding yoke portion are separately formed and secured to each other to form the steel lamination.

4. The stator assembly as in claim 1, wherein the number of edges of the polygon shape is equal to the number of teeth of the stator.

5. The stator assembly as in claim 1, wherein the teeth have and the yoke portion have a constant thickness.

6. The stator assembly as in claim 1, wherein each of the steel laminations has a hexagon shape.

7. The stator assembly as in claim 1, further comprising a first end cap part and a second end cap part, wherein the first end cap part covers partly a first end of the stator assembly and the second end part covers partly a second opposite end of the stator assembly.

8. The stator assembly as in claim 7, wherein the first end cap part is secured to the second end cap part by a plurality of fasteners.

9. The stator assembly as in claim 7, wherein the first end cap part and the second end cap part each have two or more open areas where the stack of several steel laminations are viewable.

10. The stator assembly as in claim 9, wherein the first end cap part and the second end cap part are formed from plastic.

11. The stator assembly as in claim 7, wherein the first end cap part and the second end cap part are formed from plastic.

12. The stator assembly as in claim 10, wherein the teeth and their corresponding yoke portion are separately formed and secured to each other to form the steel lamination.

13. The stator assembly as in claim 10, wherein the number of edges of the polygon shape is equal to the number of teeth of the stator.

14. The stator assembly as in claim 10, wherein the teeth have and the yoke portion have a constant thickness.

15. The stator assembly as in claim 10, wherein each of the steel laminations has a hexagon shape.

16. A brushless gear motor assembly including the stator assembly of claim 1.

17. The brushless gear motor assembly as in claim 16, wherein the brushless gear motor assembly includes a rotor assembly, a gearbox and an electronic control board.

18. The brushless gear motor assembly as in claim 16, further comprising a first end cap part and a second end cap part, wherein the first end cap part covers partly a first end of the stator assembly and the second end part covers partly a second opposite end of the stator assembly.

19. The brushless gear motor assembly as in claim 18, wherein the first end cap part is secured to the second end cap part by a plurality of fasteners.

20. The brushless gear motor assembly as in claim 18, wherein the first end cap part and the second end cap part each have two or more open areas where the stack of several steel laminations are viewable and the first end cap part and the second end cap part are formed from plastic.
